(19) United States
(12) Patent Application Publication
(10) Pub. No.: US 2026/0132751 A1
(43) Pub. Date: May 14, 2026

(54) CONTROLLER FOR VEHICLE

(71) Applicant: TOYOTA JIDOSHA KABUSHIKI KAISHA, Toyota-shi (JP)

(72) Inventor: Ryoji YAMAMOTO, Okazaki-shi (JP)

(73) Assignee: TOYOTA JIDOSHA KABUSHIKI KAISHA, Toyota-shi (JP)

(21) Appl. No.: 19/376,431

(22) Filed: Oct. 31, 2025

(30) Foreign Application Priority Data
Nov. 12, 2024 (JP) 2024-197297

(51) Int. Cl. F02D 41/02; B60W 20/16; F02D 41/00; F02D 41/14; F02P 5/04; F02P 5/15

(52) U.S. Cl. CPC F02D 41/0235; B60W 20/16; F02D 41/0052; F02D 41/1454; F02D 41/1475; F02P 5/045; F02P 5/15; F02D 2041/0265; F02D 2041/1468; F02D 2250/36

(57) ABSTRACT

A controller is used for a vehicle equipped with an engine is provided. The engine includes a three-way catalyst device disposed in an exhaust passage. The controller includes processing circuitry. The processing circuitry is configured to execute a determination process that determines whether a discharge amount of ammonia discharged from the three-way catalyst device is relatively large, and a combustion temperature reduction process that reduces a combustion temperature of the engine when the determination process determines that the discharge amount is relatively large.

### CROSS-REFERENCE TO RELATED APPLICATIONS

This application is based upon and claims the benefit of priority from Japanese Patent Application No. 2024-197297, filed on Nov. 12, 2024, the entire contents of which are incorporated herein by reference.

### BACKGROUND

### 1. Field

The present disclosure relates to a controller for a vehicle.

### 2. Description of Related Art

JP2015-124683A discloses a controller for a hybrid electric vehicle including, as drive sources, a motor and an engine that includes a three-way catalyst device. The hybrid electric vehicle that employs this controller is configured to switch, depending on operating conditions, between an electric drive mode, in which the engine is stopped and the motor drives the vehicle, and a hybrid travel mode, in which the engine is operated to propel the vehicle. The disclosed controller suppresses the emission of NOx to the atmosphere by increasing the fuel injection amount of the engine when switching from the motor travel mode to the hybrid travel mode.

When the interior of the three-way catalyst device is in a reducing atmosphere and at a high temperature, ammonia may be generated. Accordingly, when the fuel injection amount is increased in order to reduce the NOx emission amount, the emission amount of ammonia may increase.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a vehicle equipped with an engine is provided. The engine includes a three-way catalyst device disposed in an exhaust passage. The controller includes processing circuitry. The processing circuitry is configured to execute a determination process that determines whether a discharge amount of ammonia discharged from the three-way catalyst device is relatively large, and a combustion temperature reduction process that reduces a combustion temperature of the engine when the determination process determines that the discharge amount is relatively large.

Other features and aspects will be apparent from the following detailed description, the drawings, and the claims.

### BRIEF DESCRIPTION OF THE DRAWINGS

FIG. 1 is a schematic diagram showing a configuration of a controller for a vehicle according to an embodiment.

FIG. 2 is a flowchart showing processes executed by the controller shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a controller for a vehicle will be described in detail.

### Configuration of Vehicle Controller

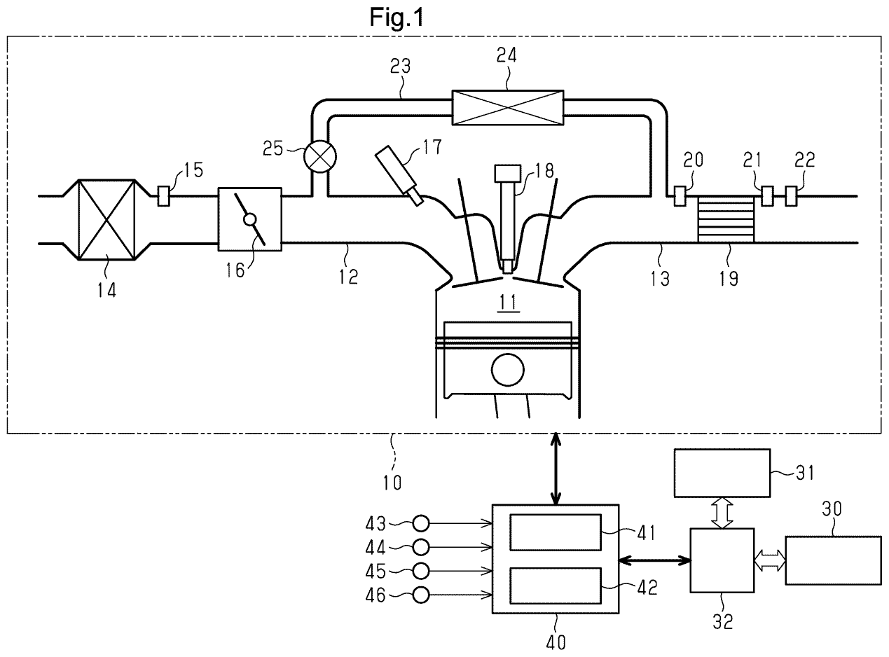

The configuration of the present embodiment will be described with reference to FIG. 1. The vehicle to which the controller of the present embodiment is applied is a hybrid electric vehicle that includes, as drive sources for traveling, an engine 10 that generates a driving force by combustion of fuel and a motor 30 that generates a driving force by power supply from a battery 31. The motor 30 is electrically connected to the battery 31 via the inverter 32.

The engine 10 includes a combustion chamber 11 for burning an air-fuel mixture, an intake passage 12 that is a path for introducing intake air into the combustion chamber 11, and an exhaust passage 13 that is a path for discharging exhaust gas from the combustion chamber 11. The intake passage 12 is provided with an air cleaner 14 that filters impurities such as dust in the intake air, an air flow meter 15 that detects a flow rate of the intake air, and a throttle valve 16 that adjusts the flow rate of the intake air. The engine 10 includes an injector 17 that injects fuel into intake air used for combustion in the combustion chamber 11, and an ignition device 18 that ignites an air-fuel mixture in the combustion chamber 11 by spark discharge. A three-way catalyst device 19 carrying a three-way catalyst for purifying exhaust gas is provided in the exhaust passage 13 of the engine 10. The three-way catalyst device 19 has an oxygen storage capacity. The exhaust passage 13 is provided with two air-fuel ratio sensors, i.e., a front air-fuel ratio sensor 20 and a rear air-fuel ratio sensor 21. The front air-fuel ratio sensor 20 is disposed in a section of the exhaust passage 13 upstream of the three-way catalyst device 19. The rear air-fuel ratio sensor 21 is disposed in a section of the exhaust passage 13 downstream of the three-way catalyst device 19. A NOx sensor 22 for detecting the amount of nitrogen oxides (NOx) in the exhaust gas is provided in a section of the exhaust passage 13 downstream of the three-way catalyst device 19. The engine 10 further includes an exhaust gas recirculation (EGR) passage 23, which is a path for recirculating exhaust gas into intake air. In the following description, the exhaust gas recirculated into the intake air through the EGR passage 23 is referred to as EGR gas. An EGR cooler 24 that cools the EGR gas and an EGR valve 25 that adjusts the flow rate of the EGR gas are disposed in the EGR passage 23.

The controller of the present embodiment is an electronic control unit 40 including processing circuitry 41 and a storage device 42. The storage device 42 stores a program and data for controlling the vehicle. The electronic control unit 40 executes various processes for controlling the vehicle by the processing circuitry 41 executing a program read from the storage device 42. Detection results of various sensors disposed in various parts of the vehicle are input to the electronic control unit 40. The sensors disposed in the vehicle include a crank angle sensor 43, a resolver 44, an accelerator pedal sensor 45, and a vehicle speed sensor 46 in addition to the air flow meter 15, the front air-fuel ratio sensor 20, the rear air-fuel ratio sensor 21, and the NOx sensor 22 described above. The crank angle sensor 43 is a sensor that detects a crank angle of the engine 10, and the resolver 44 is a sensor that detects a rotation angle of the motor 30. The accelerator pedal sensor 45 is a sensor that detects the amount of depression of the accelerator pedal by the driver, and the vehicle speed sensor 46 is a sensor that detects the vehicle speed. The electronic control unit 40 performs control of the vehicle including control of the engine 10 and the motor 30 based on the detection results of these sensors. The electronic control unit 40 calculates the engine rotation speed Ne based on the detection result of the crank angle sensor 43. The electronic control unit 40 calculates the engine load factor Kl based on the detection result of the air flow meter 15, the calculation result of the engine rotation speed Ne, and the like. The engine load factor Kl represents the filling factor of air in the combustion chamber 11.

The electronic control unit 40 performs intermittent operation control of the engine 10. In the intermittent operation control, the electronic control unit 40 automatically stops and automatically restarts the engine 10 in accordance with the traveling state of the vehicle and the charging state of the battery 31. The intermittent operation control is performed for the purpose of switching between electric traveling in which the vehicle travels by stopping the engine 10 and driving the motor 30 and hybrid traveling in which the vehicle travels by driving the engine 10, performing idle reduction, and the like.

### Air-Fuel Ratio Control of Engine 10

A three-way catalyst and an oxygen storage agent are carried on a three-way catalyst device 19 disposed in an exhaust passage 13 of an engine 10. The three-way catalyst purifies the exhaust gas by oxidizing unburned fuel components (HC, CO) and reducing NOx. The three-way catalyst exhibits the maximum exhaust purification ability under a stoichiometric atmosphere. The oxygen storage agent stores oxygen in the exhaust gas under a lean atmosphere in which oxygen is excessive, and releases the stored oxygen into the exhaust gas under a rich atmosphere in which oxygen is deficient.

As a part of the control of the engine 10, the electronic control unit 40 performs air-fuel ratio control of the air-fuel mixture burned in the combustion chamber 11 so that the three-way catalyst device 19 can effectively purify the exhaust gas. The electronic control unit 40 performs air-fuel ratio control through two types of feedback control, namely, air-fuel ratio main feedback control based on the detection result of the front air-fuel ratio sensor 20 and air-fuel ratio sub-feedback control based on the detection result of the rear air-fuel ratio sensor 21. In the following description, the “feedback control” is referred to as “F/B control.” As the air-fuel ratio main F/B control, the electronic control unit 40 performs control to adjust the fuel injection amount so that the air-fuel ratio detection value of the front air-fuel ratio sensor 20 becomes a value equal to the target air-fuel ratio. As the air-fuel ratio sub F/B control, the electronic control unit 40 performs control to alternately switch the target air-fuel ratio between a lean air-fuel ratio leaner than the stoichiometric air-fuel ratio and a rich air-fuel ratio richer than the stoichiometric air-fuel ratio, based on the detection result of the rear air-fuel ratio sensor 21. In detail, in the air-fuel ratio sub F/B control, the electronic control unit 40 switches the target air-fuel ratio from the lean air-fuel ratio to the rich air-fuel ratio when the air-fuel ratio detection value of the rear air-fuel ratio sensor 21 becomes a value indicating the lean air-fuel ratio. The electronic control unit 40 switches the target air-fuel ratio from the rich air-fuel ratio to the lean air-fuel ratio when the air-fuel ratio detection value of the rear air-fuel ratio sensor 21 becomes a value indicating the rich air-fuel ratio.

When combustion is performed at a lean air-fuel ratio in the combustion chamber 11, lean exhaust gas containing excess oxygen that is not consumed by combustion flows into the three-way catalyst device 19. At this time, the inside of the three-way catalyst device 19 is maintained in a stoichiometric atmosphere because the oxygen storage agent stores oxygen in the exhaust gas. Therefore, the air-fuel ratio detection value of the rear air-fuel ratio sensor 21 at this time becomes a value indicating the stoichiometric air-fuel ratio. However, there is an upper limit to the amount of oxygen that can be stored in the three-way catalyst device 19. When the oxygen storage amount of the three-way catalyst device 19 reaches the upper limit, lean exhaust gas is discharged from the three-way catalyst device 19. Therefore, the air-fuel ratio detection value of the rear air-fuel ratio sensor 21 changes from a value indicating the stoichiometric air-fuel ratio to a value indicating the lean air-fuel ratio. In response to this, the electronic control unit 40 switches the target air-fuel ratio from the lean air-fuel ratio to the rich air-fuel ratio in the air-fuel ratio sub F/B control. When combustion is performed at a rich air-fuel ratio in the combustion chamber 11, oxygen-deficient rich exhaust gas flows into the three-way catalyst device 19. At this time, the inside of the three-way catalyst device 19 is maintained in a stoichiometric atmosphere because the oxygen storage agent releases the stored oxygen. Therefore, the air-fuel ratio detection value of the rear air-fuel ratio sensor 21 becomes a value indicating the stoichiometric air-fuel ratio. Thereafter, when the three-way catalyst device 19 releases all the stored oxygen, the rich exhaust gas is discharged from the three-way catalyst device 19. Therefore, the air-fuel ratio detection value of the rear air-fuel ratio sensor 21 changes from a value indicating the stoichiometric air-fuel ratio to a value indicating the rich air-fuel ratio. In response to this, the electronic control unit 40 switches the target air-fuel ratio from the rich air-fuel ratio to the lean air-fuel ratio in the air-fuel ratio sub F/B control. In this way, the electronic control unit 40 alternately switches the target air-fuel ratio between the lean air-fuel ratio and the rich air-fuel ratio in the air-fuel ratio sub F/B control.

### Ammonia Emission Suppression Control

In the three-way catalyst device 19, ammonia may be produced when the inside thereof is in a high-temperature oxygen-deficient state. The condition for generating ammonia in the three-way catalyst device 19 may be satisfied in the catalyst warm-up process after the cold start of the engine 10, immediately after the return from the fuel cut, immediately after the return from the intermittent stop, or the like. Even during the sulfur poisoning recovery control of the three-way catalyst device 19, the ammonia generation condition may be satisfied. When ammonia is generated in the three-way catalyst device 19, ammonia exceeding an allowable amount may be emitted to the outside air. In the case of the present embodiment, the electronic control unit 40 performs control for suppressing the emission of ammonia.

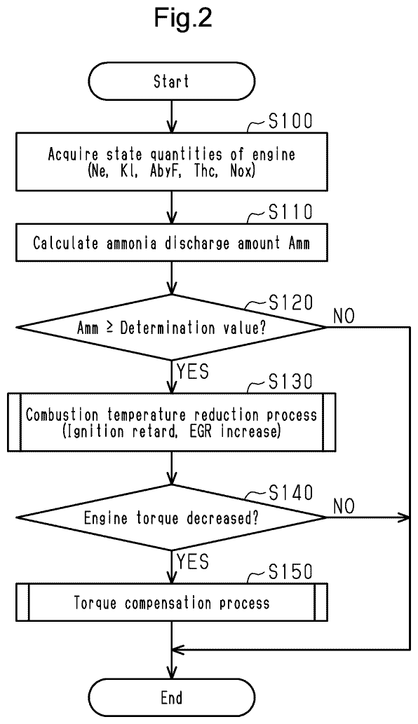

FIG. 2 shows a flow of processes executed by the electronic control unit 40 for the ammonia emission suppression control. During operation of the engine 10, the electronic control unit 40 repeatedly executes the processes of FIG. 2 at each predetermined control cycle.

In step S100 of FIG. 2, the ECU 40 acquires a state quantity indicating the operating state of the engine 10. In the process shown in FIG. 2, the ECU 40 acquires the engine rotation speed Ne, the engine load factor Kl, the air-fuel ratio AbyF, the catalyst temperature Thc, and the NOx emission amount Nox in step S100. In the following step S110, the ECU 40 calculates the ammonia discharge amount Amm from the three-way catalyst device 19 based on the obtained state quantity of the engine 10. The electronic control unit 40 calculates the ammonia discharge amount Amm by using a physical model indicating the relationship between the state quantity of the engine 10 and the ammonia discharge amount Amm.

Subsequently, in the next step S120, the ECU 40 determines whether the ammonia discharge amount Amm is relatively large. To be specific, in step S120, the ECU 40 determines whether the ammonia discharge amount Amm calculated in step S110 is equal to or larger than a predetermined determination value. If it is determined that the ammonia discharge amount Amm is less than the determination value (NO), the electronic control unit 40 ends the processes of FIG. 2 in the current control cycle. On the other hand, if it is determined that the ammonia discharge amount Amm is equal to or larger than the determination value (YES), the ECU 40 proceeds to step S130.

In step S130, the ECU 40 executes a combustion temperature reduction process that reduces the combustion temperature in the combustion chamber 11. Examples of the combustion temperature reduction process include an EGR increase process of increasing the recirculation amount of the exhaust gas to the intake air and an ignition retard process of retarding the ignition timing. As the combustion temperature reduction process, one of the EGR increase process and the ignition retard process may be executed, or both of them may be executed.

Subsequently, in step S140, the ECU 40 determines whether the engine torque has decreased due to the execution of the combustion temperature reduction process. The electronic control unit 40 estimates the engine torque based on the detection result of the resolver 44 disposed in the motor 30. The ECU 40 performs the determination in step S140 based on the estimated engine torque. If it is determined that the engine torque has not decreased (NO), the electronic control unit 40 ends the processes of FIG. 2 in the current control cycle. On the other hand, when determining that the engine torque has decreased (YES), the ECU 40 advances the process to step S150.

In step S150, the ECU 40 executes a torque compensation process for compensating for the decrease in the engine torque by increasing the motor torque. Then, the electronic control unit 40 ends the processes of FIG. 2 in the current control cycle.

### Operation of the Embodiment

When the inside of the three-way catalyst device 19 is in a high-temperature oxygen-deficient state, ammonia may be produced. Such an ammonia production condition is likely to be satisfied when the operation of the engine 10 is resumed, such as during catalyst warm-up after a cold start, at the time of return from an intermittent stop, or at the time of return from a fuel cut. The reason for this is as follows.

While the engine 10 is stopped, the exhaust gas in the exhaust passage 13 is replaced with air. Therefore, the three-way catalyst device 19 stores a large amount of oxygen when the operation of the engine 10 is restarted. Therefore, when the air-fuel ratio sub F/B control is started immediately after the restart of the operation of the engine 10, the rich air-fuel ratio is set as the target air-fuel ratio. As a result, rich combustion is performed in the combustion chamber 11, and rich exhaust gas flows into the three-way catalyst device 19. Therefore, immediately after the operation of the engine 10 is restarted, the inside of the three-way catalyst device 19 is in a high-temperature oxygen-deficient state, and ammonia is likely to be generated.

In this embodiment, the ECU 40 executes a determination process for determining whether the ammonia discharge amount Amm from the three-way catalyst device 19 is relatively large (S120). If it is determined in the determination process that the ammonia discharge amount Amm is relatively large (S120: YES), the ECU 40 executes a combustion temperature reduction process that reduces the combustion temperature of the engine 10 (S130). When the combustion temperature falls, the temperature of the exhaust gas flowing through the exhaust passage 13 falls, so the temperature inside the three-way catalyst device 19 also falls. As described above, ammonia is easily generated when the inside of the three-way catalyst device 19 is in a high-temperature oxygen-deficient state. Therefore, when the combustion temperature reduction process is executed, the generation of ammonia in the three-way catalyst device 19 is suppressed. As a result, the emission of ammonia from the engine 10 to the outside air is suppressed.

When the combustion temperature decreases, the combustion efficiency deteriorates and the engine torque decreases. On the other hand, when the engine torque is reduced by the execution of the combustion temperature reduction process (S140), the ECU 40 executes a torque compensation process of compensating for the reduction in the engine torque by increasing the motor torque. Therefore, even when the engine torque is reduced by the combustion temperature reduction process, the driving force of the vehicle is maintained.

### Advantages of the Embodiment

The controller for a vehicle according to the present embodiment described above has the following advantages.
(1) The electronic control unit 40 is a controller for the vehicle equipped with the engine 10. The engine 10 includes the three-way catalyst device 19, which is disposed in the exhaust passage 13. The electronic control unit 40 executes the determination process, which determines whether the ammonia discharge amount Amm of the three-way catalyst device 19 is relatively large. When it is determined in the determination process that the ammonia discharge amount Amm is relatively large, the electronic control unit 40 executes the combustion temperature reduction process, which reduces the combustion temperature of the engine 10. In the three-way catalyst device 19, ammonia is produced when the inside thereof is in a high-temperature oxygen-deficient state. Therefore, when the combustion temperature of the engine 10 is reduced, the temperature of the three-way catalyst device 19 is reduced, so that ammonia is less likely to be generated. The generation of ammonia in the three-way catalyst device 19 can also be suppressed by performing lean combustion to establish an oxygen-rich state inside the three-way catalyst device 19. However, when the lean combustion is performed in a state in which the three-way catalyst device 19 stores a large amount of oxygen, the NOx emission amount Nox of the engine 10 increases. In this regard, in the case of the present embodiment, the generation of ammonia is suppressed by reducing the combustion temperature while performing rich combustion. Therefore, the controller for a vehicle according to the present embodiment has an effect of suppressing emissions of both NOx and ammonia from the engine 10.
(2) The electronic control unit 40 performs the air-fuel ratio sub F/B control based on the detection result of the rear air-fuel ratio sensor 21, which is disposed in the section of the exhaust passage 13 downstream of the three-way catalyst device 19. When the air-fuel ratio sub F/B control is started, the rich combustion is performed immediately after the restart of the operation of the engine 10, and ammonia is likely to be generated in the three-way catalyst device 19. In the present embodiment, even in such a situation, where ammonia is likely to be generated, it is possible to suppress the emission of ammonia from the engine 10 by reducing the combustion temperature.
(3) The electronic control unit 40 executes one or both of the process of increasing the recirculation amount of the exhaust gas to the intake air and the process of retarding the ignition timing as the combustion temperature reduction process. These processes allows the combustion temperature to be reduced while performing rich combustion. Therefore, the emission of ammonia can be suppressed without increasing the emission of NOx.
(4) The electronic control unit 40 is configured to execute the torque compensation process, which compensates for reduction in the engine torque resulting from execution of the combustion temperature reduction process by supplying motor torque. This suppresses a reduction in the driving force of the vehicle resulting from the execution of the combustion temperature reduction process.

### Other Embodiments

The above-described embodiments may be modified as follows. The above-described embodiment and the following modifications can be combined as long as the combined modifications remain technically consistent with each other.

When the engine 10 includes a variable valve mechanism, a process of driving the variable valve mechanism so as to increase the valve overlap amount can be executed as the combustion temperature reduction process. When the valve overlap amount is increased, the amount of exhaust gas that is blown back from the exhaust passage 13 to the combustion chamber 11, i.e., the so-called internal EGR amount, increases, so the combustion temperature of the engine 10 decreases. A process other than the ignition retard process or the process of increasing the EGR amount may be executed as the combustion temperature reduction process as long as the process is a process of reducing the combustion temperature while performing rich combustion.

An ammonia sensor that detects the amount of ammonia in the exhaust gas may be provided in a section of the exhaust passage 13 downstream of the three-way catalyst device 19, and the determination in step S120 in FIG. 2 may be made based on the detection result.

In the above embodiment, the ECU 40 determines that the ammonia discharge amount Amm is relatively large when the ammonia discharge amount Amm calculated in step S110 is equal to or larger than a predetermined determination value. However, the electronic control unit 40 may judge that the ammonia discharge amount Amm is relatively large if more ammonia is produced compared with a certain state, for example, if more ammonia is produced compared with a state in which no or almost no ammonia is produced. In such a case, the electronic control unit 40 may determine whether the ammonia discharge amount Amm is relatively large based on the operating conditions of the engine 10 without estimating or detecting the ammonia discharge amount Amm. Specifically, it is determined whether a condition for generating ammonia in the three-way catalyst device 19 is satisfied from the operating condition of the engine 10, and it is determined that the ammonia discharge amount Amm is relatively large when the condition for generating ammonia is satisfied. For example, it may be determined that the ammonia discharge amount Amm is relatively large during catalyst warm-up at the time of cold start of the engine 10, at the time of return from intermittent stop, at the time of return from fuel cut, or the like. Whether the ammonia discharge amount Amm is relatively large may be determined by determining whether the condition for generating ammonia in the three-way catalyst device 19 is satisfied based on the state quantity of the engine 10 such as the air-fuel ratio AbyF of the engine 10 or the temperature of the three-way catalyst device 19.

When the influence of the decrease in the engine torque due to the execution of the combustion temperature reduction process can be ignored, or when the vehicle has a configuration in which the torque compensation by the motor 30 cannot be executed, the torque compensation process may be omitted and the ammonia emission reduction control may be executed. For example, the process of steps S140 and S150 in FIG. 2 may be omitted, and the ammonia emission suppression control may be executed. In the case of such a configuration, the controller of the above embodiment can also be applied to an engine vehicle in which only an engine is mounted as a drive source for traveling.

The target air-fuel ratio may be switched between the rich air-fuel ratio and the lean air-fuel ratio without using the rear air-fuel ratio sensor 21. For example, the oxygen storage amount of the three-way catalyst device 19 may be estimated based on the state quantity of the engine 10 such as the intake air amount or the air-fuel ratio, and the target air-fuel ratio may be switched based on the estimation result.

The controller is not limited to a device realized by the electronic control unit 40 including the processing circuitry 41 and the storage device 42. For example, the controller may include a dedicated hardware circuit (e.g. an application specific integrated circuit: ASIC) that executes at least part of the processes executed in the above-described embodiment. That is, the controller may be modified as long as it includes processing circuitry that has any one of the following configurations (a) to (c).
(a) Processing circuitry including at least one processor that executes all of the above-described processes according to programs and at least one program storage device such as a ROM that stores the programs.
(b) Processing circuitry including at least one processor and at least one program storage device that execute part of the above-described processes according to the programs and at least one dedicated hardware circuit that executes the remaining processes.
(c) Processing circuitry including at least dedicated hardware circuit that executes all of the above-described processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle equipped with an engine, the engine including a three-way catalyst device disposed in an exhaust passage, wherein
the controller comprises processing circuitry, and
the processing circuitry is configured to execute
a determination process that determines whether a discharge amount of ammonia discharged from the three-way catalyst device is relatively large; and
a combustion temperature reduction process that reduces a combustion temperature of the engine when the determination process determines that the discharge amount is relatively large.

2. The controller for the vehicle according to claim 1, wherein
the engine further includes an air-fuel ratio sensor disposed in a section of the exhaust passage downstream of the three-way catalyst device, and
the processing circuitry is configured to execute an air-fuel ratio sub-feedback control based on a detection result of the air-fuel ratio sensor.

3. The controller for the vehicle according to claim 1, wherein the combustion temperature reduction process includes a process that increases a recirculation amount of exhaust gas to intake air.

4. The controller for the vehicle according to claim 1, wherein the combustion temperature reduction process includes a process that retards an ignition timing.

5. The controller for the vehicle according to claim 1, wherein
the vehicle is a hybrid electric vehicle including the engine and a motor as drive sources for traveling, and
the processing circuitry is configured to execute a torque compensation process that compensates for a reduction in engine torque resulting from execution of the combustion temperature reduction process by supplying motor torque.
